(19) United States
(12) Patent Application Publication
(10) Pub. No.: US 2009/0110284 A1
(43) Pub. Date: Apr. 30, 2009

(54) System and Method for Sorting Objects Using OCR and Speech Recognition Techniques

(75) Inventors: Thorsten Lamprecht, Konstanz (DE); Ilian Pashov, Konstanz (DE); Walter Rosenbaum, Paris (FR)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/302,210

(22) PCT Filed: May 22, 2007
(86) PCT No.: PCT/EP2007/054909

§ 371 Date: Jan. 16, 2009

Related U.S. Application Data
(60) Provisional application No. 60/802,871, filed on May 23, 2006.

(51) Int. Cl. G06K 9/00

(52) U.S. Cl. 382/187

(57) ABSTRACT

To perform character recognition on an object for automatic processing of the object in a processing system, where the object contains at least one character string of processing information, a character string spoken by an operator is processed by a speech recognition procedure to generate a candidate list containing at least one candidate corresponding to the operator-spoken character string. The candidate list and a digital image of an area containing the processing information are made available for an optical character recognition procedure. The OCR procedure is performed on the digital image in coordination with the candidate list to determine if a character string recognized by the OCR procedure performed on the digital image corresponds to a candidate in the candidate list. Any such corresponding candidate is outputted as the character string on the object.

### BACKGROUND OF THE INVENTION

The various embodiments described herein generally relate to systems for processing objects, such as mail items. More particularly, the various embodiments relate to a system and method for performing character recognition for the purpose of affecting efficient automatic processing of objects.

Mail processing systems are highly automated to handle the massive volume of mail that needs to be processed on a daily basis. For example, such systems utilize procedures and equipment to perform optical character recognition (OCR) to automatically recognize the destination address on an envelope or package, and to interpret into machine-readable alpha-numeric characters. An automated address recognition procedure based on OCR is described, for example, in EP 975 442.

The success of automatic address recognition depends largely on address quality. Small mail items such as letters and post cards are automatically sortable by means of an OCR process because address location is constrained and an increasing percentage of such mail items is machine printed in a manner that the OCR process is relatively easily accomplished. In contrast, other mail items such as parcels and packets are frequently hand addressed and the address information can be inscribed almost anywhere on a packet or parcel. Also, the surfaces of such packets may frequently be non-flat with an uneven surface or curvature. Such non-flat surfaces are likely to degrade the quality of the scanned image which is then subject to an OCR process.

Furthermore, intelligent address reading by means of an OCR process is further degraded by orthographic mistakes that a sender may inadvertently make. These errors may be spelling errors or misplaced address information. Such orthographic problems are more common, and adversely effect sortation of packets that have their origin outside the country where they are to be sorted. Depending on their country of origin, such import packets and parcels tend to have even a higher percentage of hand-written addresses that are difficult to recognize.

Certain systems use speech recognition techniques to enable an operator to affect sortation of mail items, i.e., the operator speaks the whole address or only parts of the address, and a speech recognition system attempts to generate machine-processable address information that corresponds to the spoken address or address parts. Such a speech recognition system used for initiation of sortation, however, tends to be insufficiently reliable for operational purposes due to high error rates when the operator voicing is done in a high ambient noise environment.

U.S. Pat. No. 6,587,572 describes a direct speech recognition procedure for video coding mail items that an OCR process rejected. Because of low intrinsic reliability of speech recognition, the described procedure uses speech recognition to display multiple alternatives as resolved from the operator's utterance, and displays them for operator selection. This recursive operator voicing and selection procedure makes this process operationally relatively slow.

Further, other known sortation procedures couple speech recognition and OCR procedures for addresses that have been rejected by online OCR methods and have entered video coding for operator coding. Such a combined speech recognition and OCR procedure is disclosed in U.S. Pat. No. 6,577,749 and H. J. Grundmann and W. Rosenbaum, “Interactive Video Coding—the key to financial success”, IMechE Conference Transactions 2001-6, pages 265. There, the failed OCR address pass is used to reduce the number of directory candidates and thereby lessen the ambiguity the speech recognition process must resolve. Additionally, the operators are in a video coding environment that is removed from a noisy induction area and, thereby, is removed from the deleterious effects of ambient noise. Furthermore, the speech recognition procedure produces a set of alternatives among which the correct street name is assumed to reside. This list of candidates is used with specific keystroke data as input to restart an OCR process, which is enhanced via the restricted set of alternatives provided by the speech recognition procedure.

High ambient noise is an inhibitor of using speech at the induction area of a mail sorting system. Noise can be sporadic, such as loud background noise from machinery or chutes, nearby talking or even the operator's throat clearing or chance remarks to a colleague. The speech recognition process can interpret such a spurious sound as an utterance, and output its best match while the operator's intended utterance is additionally registered and recognized thereby creating another speech recognition sortation decision.

It is further known as used in so-called pick-and-place inventory operations, that direct speech recognition processing can be used with audio feedback. In this scenario, the induction operator speaks the address into a microphone attached to a speech recognition processor. Errors or any non-recognition are caught by use of audio feedback. That is, the speech recognition results are spoken back to the induction operator via speech synthesis or pre-recorded segments. However, a disadvantage is that the induction operator needs to wait for the audio feedback before releasing the packet, or parcel, i.e., until the address is confirmed to the operator, so that the operator's productivity is significantly reduced. Additionally, the induction operator is unable to overlap the voicing of one address while physically grasping and focusing on the next packet or parcel, to be read, spoken and inducted.

### SUMMARY OF THE INVENTION

There is, therefore, a need for an improved system and method for performing character recognition on objects for the purpose of affecting efficient automatic processing of these objects.

Accordingly, one aspect involves a method of performing character recognition on an object for affecting efficient automatic processing of the object in a processing system, wherein the object contains at least one character string of processing information. A character string spoken by an operator is processed by a speech recognition procedure to generate a candidate list containing at least one candidate corresponding to the operator-spoken character string. The candidate list and a digital image of an area containing the processing information are made available for an optical character recognition (OCR) procedure. The OCR procedure is performed on the digital image in coordination with the candidate list to determine if a character string recognized by the OCR procedure performed on the digital image corresponds to a candidate in the candidate list generated by the speech recognition procedure. Any such corresponding candidate is outputted as the character string on the object.

Another aspect involves a system for affecting automatic processing of an object containing on an outer surface at least one character string of a processing information. The system includes a speech recognition system having a port configured to couple to a communication device of an operator to input at least one spoken character string, wherein the speech recognition system is configured to generate a candidate list containing at least one candidate corresponding to the spoken character string. A processing system is configured to perform an optical character recognition (OCR) procedure, and is coupled to receive a digital image of an area containing the processing information on the object and to access the candidate list. A controller is coupled to the speech recognition system and the processing system, and configured to subject the digital image to the OCR procedure in coordination with the candidate list to determine if a character string recognized by the OCR procedure performed on the digital image corresponds to a candidate in the candidate list generated by the speech recognition procedure. Any such corresponding candidate is outputted as the character string on the object.

The method and system provide for improved recognition of character strings on objects. The employed OCR process is performed upon and restricted to the subset of possible alternatives generated by the speech recognition procedure, which may be referred to as a voice directory of alternatives. Hence, instead of performing the OCR process on a comprehensive directory the OCR process is restricted to the voice directory of alternatives generated for the currently processed object.

In one embodiment, the method and system minimize synchronization problems between a recognized character string and an introduced object. In that embodiment, a signal noticeable by the operator is generated. The signal may be generated at any specified point in the speech recognition process. When the object is not detected within a predetermined period of time of generating the signal the generated at least one candidate is discarded. However, when the object is detected within the predetermined period of time, the digital image is subjected to the OCR procedure. The signal may be an audio signal, a visual signal or an audio-visual signal.

In one embodiment, the processing system processes mail items such as letters, parcels and packets. These mail items contain destination addresses on outer surfaces, or visible through transparent windows, as processing information used by the processing system to affect efficient sorting of the mail items.

Accordingly, the system and method provide for a seamless and synergistic combination of optical character recognition and speech recognition of an operator enunciating the same address that will be scanned in the OCR process. The system and method ensure synchronization between the speech recognition result and the OCR result by detecting and preventing any loss of synchronization. The speech recognition process improves and optimizes the OCR results that are then used to yield a unique identification of the address elements of an address.

In a mail processing application, the speech recognition process provides a subdirectory of possible candidates for the address element. These candidates are then passed to the OCR process for final identification of the address elements using the principles of OCR pattern recognition. Speech recognition may not be restrained to make a unique identification, but may rather provide a set of alternatives based on enunciation that are assumed to be broad enough to contain amongst other candidates the correct identity of the address element.

Advantageously, the system and method provide for a reduced speech recognition error rate without recourse to audio feedback, and for speech coding to be performed in a flexible manner with look-ahead overlap between, for example, the packet whose address has just been voiced and the next item to be processed. In addition, the system and method enable accurate, effective speech coding of full addresses with city, state, street and addressee as required to complete sortation to any level of delivery.

### BRIEF DESCRIPTION OF THE SEVERAL VIEWS OF THE DRAWINGS

The novel features and method steps characteristic of the invention are set out in the claims below. The invention itself, however, as well as other inventive features and advantages thereof, are best understood by reference to the detailed description, which follows, when read in conjunction with the accompanying drawings, wherein:

FIG. 1 depicts a schematic overview of one embodiment of a mail processing system that uses OCR and speech recognition techniques; and

FIG. 2 depicts a process flow of one embodiment of a method of processing mail.

### DETAILED DESCRIPTION OF THE INVENTION

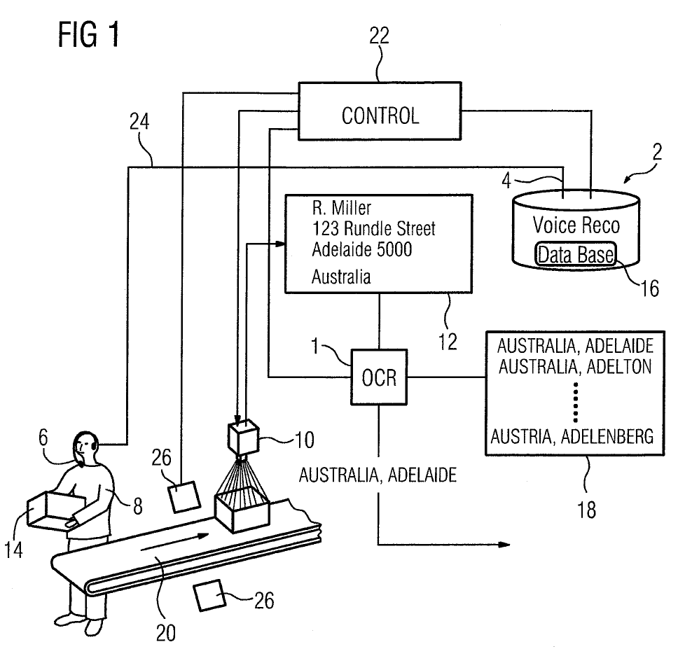

FIG. 1 illustrates an overview of one embodiment of a processing system that uses OCR and speech recognition techniques for affecting efficient automatic processing of objects according to processing information on the objects. In one embodiment, the processing system is a mail processing system configured to sort mail items according to address information on the mail items. A mail item, as used herein, generally refers to any item typically handled and transported by a postal service, such as the postal services of the U.S. or Germany, from a drop off location to a destination address. In the embodiments described herein, however, an exemplary mail item is a parcel because the address on a parcel's outer surface may be more difficult to read by an OCR process than on a letter or post card. It is contemplated, however, that the invention is not limited to recognizing destination addresses on parcels.

Further, it is contemplated that the invention is applicable to any processing of objects that carry human-readable information and are subject to a hybrid OCR and speech interpretation of that information. Such processing may include applications in production line quality control, for example, where an operator enunciates an identifying data string that is then uniquely resolved by an OCR process.

The exemplary overview of the system shown in FIG. 1 includes a speech recognition system 2 (also referred to as voice recognition system), a processing system 1 configured to perform an OCR process, hereinafter referred to as OCR system 1, and a system controller 22. The system includes further a scanner 10 configured to generate a digital image 12 of a surface of a parcel 14 transported on a conveyor 20. The system controller 22 is configured to control the operation of the system, for example, by monitoring a light barrier 26, by driving a conveyor 20, and by triggering the scanner 10 when a parcel 14 passes by and a speech recognition result has been obtained. It is contemplated that the system controller 22 is coupled to any controlled device to allow communications between the system controller 22 and the controlled devices.

The speech recognition system 2 has a port 4 coupled to a communication device 6 worn by an operator 8 located next to the conveyor 20 in an induction area of the system. In one embodiment, the communication device 6 is a speaker-microphone headset 6. Via the port 4, the speech recognition system 2 receives a speech signal generated, for example, by the headset's microphone when the operator 8 reads aloud a character string from the parcel's surface, and sends an audio signal to the headset's speaker, for example, to indicate that the speech recognition system 2 detected an utterance or when the operator 8 needs to be alerted. The headset 6 may be coupled to the port 4 either via a wire connection or a wireless connection 24.

The OCR system 1 is coupled to the scanner 10 and the speech recognition system 2 in order to subject the digital image 12 to an OCR procedure based on a (voice) directory containing at least one address candidate generated by the speech recognition system 2 (e.g., list 18 of candidates described below). The OCR system 1 determines if an address element character string processed by the OCR procedure performed on the digital image 12 corresponds to the at least one address candidate, i.e., whether the processed address character string is found in the voice directory. In the event that it is determined that the speech recognition candidate list 18 does not contain a reasonable OCR-generated match to the scanned address element character string then the OCR system 1 continues to examine and attempt to resolve the address element versus all relevant address element data in a database 16 to resolve a sortation decision independent of the speech recognition candidate list 18.

As shown in the embodiment of FIG. 1, the operator 8 grasps the parcel 14, speaks at least one character string representing a selected address element (e.g., country and city), or the whole address, into the microphone that converts voice into an electrical speech signal. The speech recognition system 2 processes the electrical speech signal by means of a speech processing software, such as VoCOn® or NaturallySpeaking® speech processing software available from Nuance Communications Inc., or any other software that converts an electrical speech signal into machine-usable information.

As indicated in FIG. 1, the speech recognition system 2 includes the database 16 containing a multitude of address elements, such as post codes (ZIP codes), city names and street names. The database 16 constitutes a comprehensive address directory and may contain the address elements organized on a country-by-country basis.

The speech recognition system 2 uses the voice utterance corresponding to the character string on the parcel 14 to select from the database 16 at least one address element candidate found to be closest to each address element spoken by the operator 8. In one embodiment, any such address element candidate has associated with it an audio score that reflects a level of confidence that the speech recognition system 2 attributes to this address element candidate. In the illustrated embodiment, the speech recognition system 2 generates a list 18 of address element candidates, such as country and city, for example, “Australia, Adelaide”, “Australia, Adelton”, “Austria, Adelenberg” and others. The list 18 reflects a ranking of the address element candidates, whereas the best result, i.e., the result with the highest audio score, is at the top of the list.

Where the speech recognition system 2 has resolved an address utterance such as “Lower West Lake Terrace Northwest” that contains many individual words, the list 18 contains the concatenation of all speech recognition candidates for each recognized individual address element. The OCR system 1 uses this concatenated list as the input for its final resolution of the address or address element.

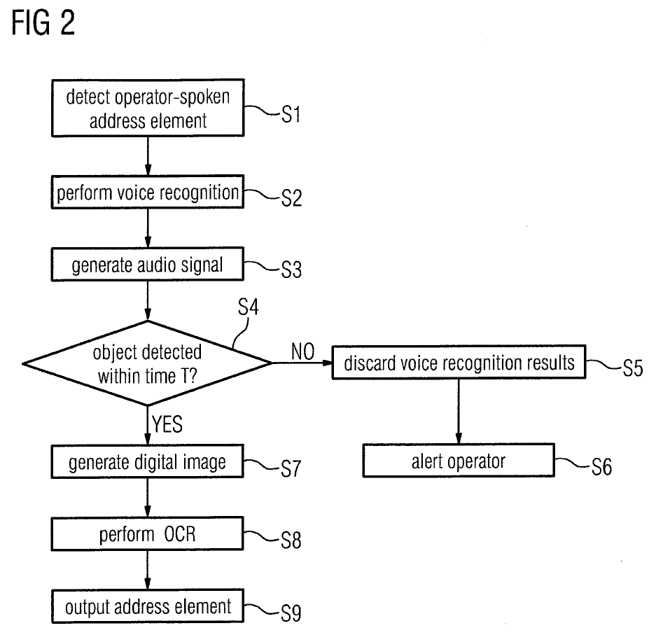

FIG. 2 depicts a process flow of one embodiment of a method of processing mail performed by the system illustrated in FIG. 1. As illustrated in FIG. 1, the operator 8 stands next to the conveyor 20 and grabs one parcel 14 after the other. The operator 8 is instructed to read at least one element of the parcel's address and to speak the at least one address element, e.g., city and state, or city and country, into the microphone. Once the operator 8 spoke the one or more selected address elements, the operator 8 places the parcel 14 on the conveyor 20 that feeds the parcel 14 to the scanner 10, which is in one embodiment arranged above the conveyor 20. In that embodiment, the operator 8 is instructed to place the parcel 14 with the address facing upward so that the scanner 10 can scan the address and generate a digital representation (image 12) of the parcel's upper surface. The light barrier 26 is configured may detect the presence of the parcel 14 on the conveyor 20, for example, to trigger the scanner 10.

Referring to steps S1 and S2, if the operator 8 intentionally speaks into the microphone the speech recognition system 2 detects the operator-spoken address element and performs speech recognition of this address element. The list 18 of address candidates represents the result of the speech recognition process, whereas one candidate with the highest audio score ideally corresponds to the operator-spoken address element. The candidates of the list 18 are now available in a machine-useable form.

Proceeding to a step S3, an audio signal intended to be audible by the operator 8 is generated, for example, simultaneous with the speech recognition process of step S2. The audio signal may be generated at the start of the speech recognition process, or at any other point of the speech recognition process, to indicate to the operator 8 that the speech recognition process recognized an utterance. In one embodiment, the audio signal is sent to the speaker of the headset 6.

The audio signal is one example of a signal indicative of a recognized utterance. However, it is contemplated that any other manner of notifying the operator 8 that the speech recognition process recognized an utterance may be employed. For example, the operator 8 may be informed in a visual manner or in a combined audio/visual manner.

Proceeding to a step S4, the procedure determines whether within a predetermined time T after the audio signal is generated, an object (parcel 14) is detected on the conveyor 20. The time T may be selected to be in the range of a few seconds. Generally, the time T is set to be consistent with the tempo of the coding operation underway. For example, for parcel sorting with a normative throughput in the order of 1,800 items per hour, one average two seconds are dedicated per item coded. In such an embodiment, the time T is set to less than a second.

If no object is detected in step S4, the procedure proceeds along the NO branch to a step S5. In step S5, the procedure interprets the failure to detect an object as a “do not use” instruction and discards the results of the list 18 generated in step S2 by the speech recognition process. As the speech recognition process is triggered by any utterance that sounds like a conscious speech input, the speech recognition process outputs results even though the operator 8, for example, only cleared his throat, or made some other utterance. Of course, in such a situation no object has been placed on the conveyor 20, and the speech recognition process is not in synchronization with an object.

Proceeding to a step S6, the procedure alerts the operator 8 about the situation detected in step S5, i.e., the detection of an utterance, but not of an object. In response, the operator 8 withholds placing the parcel 14 on the conveyor 20. The alert may be an alarm tone, or a prerecorded announcement instructing the operator 8 to withhold the parcel 14.

If in step S4 the parcel 14 is detected within the time T the procedure proceeds along the YES branch to a step S7. In step S7, the digital image 12 of the parcel's surface is generated. The digital image 12 includes the parcel's address allowing image processing software to locate the address box in the digital image 12. Locating the address box is also referred to as locating the region of interest (ROI) in the digital image 12.

Proceeding to a step S8, the procedure performs optical character recognition on the digital image 12 to determine the at least one address element on the parcel 14. As shown in FIG. 1, the candidate list 18 generated by the speech recognition system 2 is passed to the OCR system 1 along with the digital image 12 acquired by the scanner 10. The OCR system 1 performs character recognition in coordination with the candidate list 18 to determine which, if any, of the respective address candidates in this speech generated candidate list 18 corresponds with the OCR performed on the digital image 12 whereby each candidate in the list 18 is associated with the digital image 12 with an OCR system generated confidence level. Any such corresponding address element candidate is then output as the address element on the parcel 14, as indicated in a step S9.

The OCR procedure performed by the OCR system 1 is configured to apply a thresholding method to make a final selection of a single candidate from the candidate list 18. The thresholding method examines determined audio scores and OCR confidence levels of the obtained results. In this thresholding method the relative values for “high” or “low” audio score and OCR confidence levels, as well as what is considered a “close contention”, are established by testing. These values and levels vary between different OCR systems and between different speech recognition systems.

If the audio score for a given candidate in the candidate list 18 is high with no closely contending other audio scores the final candidate selection from the candidate list is made even if the related OCR confidence level is relatively weak. That is, the candidate having the highest audio score is selected.

However, if all audio scores of the candidates in the candidate list 18 are relatively low, or if one or more candidates have audio scores that are in close contention, then the final selection from the candidate list 18 requires a high OCR confidence level that in the absence of which a “tentative reject” is returned. That is, the candidate having an OCR confidence level that is at least as high as a predetermined OCR confidence level is selected. If none of the candidates meets the predetermined OCR confidence level the OCR system 1 attempts to resolve the parcel address in a manner consistent with best OCR practice.

The final identification of which candidate of the candidate list 18 is the correct identification of the address element is made by the OCR system 1. This means that the address information on the parcel 14 can be spoken at any point in the handling, or even after the operator 8 at the induction site has released the parcel 14, and is already beginning to grasp the next item. This enables a high degree of overlap of address enunciation with item handling in a look-ahead mode. The ability to perform speech recognition overlapped with next item handling and not having to wait for audio feedback results in enhanced throughput.

The combination of two essentially independent means of address element analysis creates a decision process that uses threshold values for acceptance and rejection of the automatic address interpretation so as to yield very high address acceptance rates with exceptionally low error rates. Essentially, acceptance/rejection decisions are leveraged on independent speech and OCR recognition criteria. Following is an example of such an intelligent thresholding process that takes advantage of the audio score representing the degree of assurance between a voiced utterance and a candidate and the OCR confidence level with which it has associated the image of the address with the respective candidates yielded by speech recognition.

In one embodiment, the intelligent thresholding process includes the following criteria:
When the speech recognition candidate has a high recognition confidence, the OCR correlation can be relatively weak.
Conversely when the speech recognition candidate has a relatively low recognition confidence, the OCR correlation must be high.
When the speech recognition candidate is a minimal syllable word (e.g., 2 syllables as in Paris, Togo, or China) the OCR correlation must be relatively high regardless of the recognition reliability indicated.

If the candidates resulting from the speech recognition process are rejected because the OCR result does not correlate with any of the speech recognition candidates, the speech recognition process candidates are above a given speech recognition threshold, and this sequence of events continues for a specified number of successive operator utterances, then the processing system attempts to determine if the problem is the result of loss of synchronization between voicing and the respective parcels. Accordingly, the system controller 22 attempts to determines if the latter speech recognition result correlates with the former image/OCR which would indicate a loss of synchronization having shifted the operator voicing one processing slot behind the parcel. Such a loss of synchronization may occur when a spurious voicing is somehow introduced into the operator sequencing of voicing parcel addresses. If such a speech recognition process output correlation is found by reference to the previous image/OCR, the operator 8 is alerted via an audio alarm to halt voicing. The system is then re-synchronized.

In one embodiment, the speech recognition results rejected by the OCR process are reviewed by a video coding operator, who is presented with the digital image 12, the result of the OCR correlation, the results of the speech recognition process and the recorded voice of the operator 8. If the digital image 12 and the recorded voice of the operator 8 do not correspond then an alarm is generated to signal a synchronization problem.

The video coding operator can either always hear the recorded audio or play it only if he suspects a synchronization problem, i.e., a rejected OCR result has voice candidates with a high recognition score and the digital image 12 has a good quality. If the utterance of the operator 8 does not match the address element of the digital image 12, the alarm is generated. As a consequence, the previously processed parcels 14 that have not yet been sorted are rejected.

In one embodiment, a thresholding trend is determined and monitored to intuit if a series of rejects is the result not of speech or OCR recognition deficiencies, but rather an indicator that the operator 8 utterances are out of synchronization with the parcels 14. In this case, the operator 8 may be instructed to withhold placing a parcel 14.

Additionally using speech utterance allows for those addresses that are in a foreign language and essentially not accurately or consistently pronounceable by local personnel being used for induction, in that the operator 8 speaks the country name and spells the first, e.g., first 3, characters of the city name. A larger but still constrained set of country and city names results are resolved as candidates that are then passed to the OCR system 1 to disambiguate using the digital image 12 generated by the scanner 10.

The general approach using speech to subset the directory for further OCR resolution includes in one embodiment the operator 8 inserting into the utterance a command that then instructs the system as to the nature of the related voicing. For example, the operator 8 may speak a UK address that consists of county, city and district. The operator 8 voicing facilitates the directory match by including a command <Cmd>, e.g.; <place>, that denotes that the next utterance is the city. For example, the sequence of voicing <County> (Cmd) <City> <District> hence becomes an unambiguous canonical form. In such a processing mode the speech recognition result list for each perceived voiced word are contaminated into a single unified speech directory list 18 and passed to the OCR system 1 to affect the final address resolution.

1-17. (canceled)

18. A method for performing character recognition on an object for affecting efficient automatic processing of the object in a processing system, the object containing on an outer surface at least one character string of processing information, which comprises the steps of:
processing the character string spoken by an operator by means of a speech recognition procedure to generate a candidate list containing at least one candidate corresponding to an operator-spoken character string;
making the candidate list and a digital image of an area containing the processing information available to an optical character recognition procedure;
performing the OCR procedure on the digital image upon and restricted to the candidate list for determining if a character string recognized by the OCR procedure performed on the digital image corresponds to a candidate in the candidate list generated by the speech recognition procedure; and
outputting any such corresponding candidate as the character string on the object.

19. The method according to claim 18, which further comprises:
generating a signal noticeable by the operator;
determining whether the object is detected in the processing system within a predetermined period of time of generating the signal;
discarding the candidate previously generated when the object is not detected within the predetermined period of time; and
if the object is detected within the predetermined period of time, subjecting the digital image to the optical character recognition procedure.

20. The method according to claim 19, which further comprises alerting the operator of the discarding of the candidate previously generated so that the operator withholds introducing the object into the processing system.

21. The method according to claim 18, which further comprises configuring the OCR procedure to apply a thresholding procedure that examines an audio score of a speech recognition candidate determined by the speech recognition procedure and a confidence level of at least one result provided by the OCR procedure, and the thresholding procedure selecting the character string recognized by the OCR procedure as the at least one candidate generated by the speech recognition procedure if the audio score for a given candidate is high with no closely contending other audio scores even if a related OCR confidence level is relatively weak.

22. The method according to claim 21, wherein the thresholding procedure selects the character string recognized by the OCR procedure as the at least one candidate generated by the speech recognition procedure if audio scores of candidates are relatively low, and a related OCR confidence level is high.

23. The method according to claim 21, wherein the thresholding procedure selects the character string recognized by the OCR procedure as the at least one candidate generated by the speech recognition procedure if at least one candidate has audio scores that are in close contention, and a related OCR confidence level is high.

24. The method according to claim 22, wherein the thresholding procedure rejects the character string recognized by the OCR procedure as the at least one candidate generated by the speech recognition procedure if a related OCR confidence level is low.

25. The method according to claim 24, which further comprises processing speech recognition results rejected by the OCR procedure by a video coding operator receiving the digital image, a result of the OCR procedure, a result of the speech recognition process and a recorded voice of the operator, for determining an anomaly following a video-coding entry if the digital image and the speech recognition result do not match, but the processing information is visible on the object.

26. The method according to claim 25, which further comprises generating an alarm to signal a synchronization problem if a number of anomalies is more than a specified threshold value.

27. The method according to claim 26, which further comprises selectively playing the recorded voice to the video-coding operator to generate the alarm if the recorded voice does not match the character string of the digital image.

28. The method according to claim 27, which further comprises rejecting, after the alarm, previously processed objects that have not yet been further processed.

29. The method according to claim 18, wherein the object is a mail item and the processing information is a destination address.

30. The method according to claim 18, wherein the operator-spoken character string includes individual address elements, and the candidate list contains a concatenation of all candidates for each recognized individual address element.

31. A system for affecting automatic processing of an object containing on an outer surface at least one character string of processing information, the system comprising:
a speech recognition system having a port configured to couple to a communication device of an operator to input at least one spoken character string, said speech recognition system configured to generate a candidate list containing at least one candidate corresponding to a spoken character string;
a processing system configured to perform an optical character recognition procedure, and coupled to receive a digital image of an area containing the processing information on the object and to access the candidate list; and
a controller coupled to said speech recognition system and said processing system, said controller is configured:
to subject the digital image to the OCR procedure upon and restricted to the candidate list to determine if a character string recognized by the OCR procedure performed on the digital image corresponds to a candidate in the candidate list generated by the speech recognition procedure; and
to output any such corresponding candidate as the character string on the object.

32. The system according to claim 31, wherein said controller is further configured:
to generate a signal noticeable by the operator;
to determine whether the object is detected in said processing system within a predetermined period of time of generating the signal;
to discard the candidate previously generated when the object is not detected within the predetermined period of time; and
when the object is detected within the predetermined period of time, to subject the digital image to the OCR procedure.

33. The system according to claim 32, wherein said controller is further configured to alert the operator of the discarding of the candidate previously generated so that the operator withholds introducing the object into the processing system.

34. The system according to claim 31, wherein the object is a mail item and the processing information is a destination address.
